(19) United States
(12) Patent Application Publication
(10) Pub. No.: US 2026/0302028 A1
(43) Pub. Date: Oct. 1, 2026

(54) LOW LOSS SUPERCONDUCTOR ELECTRICAL CABLE

(71) Applicant: Tokamak Energy Ltd, Milton, Abingdon, Oxfordshire (GB)

(72) Inventors: Matthew Bristow, Milton, Abingdon, Oxfordshire (GB); Greg Brittles, Milton, Abingdon, Oxfordshire (GB)

(21) Appl. No.: 19/474,958

(22) PCT Filed: Apr. 15, 2024
(86) PCT No.: PCT/EP2024/060175

§ 371 Date: Oct. 13, 2025

(30) Foreign Application Priority Data
Apr. 13, 2023 (GB) 2305442.2

(51) Int. Cl. H01F 6/06; H01B 12/06; H01B 12/16; H01F 6/00; H01R 4/68

(52) U.S. Cl. CPC H01F 6/06; H01B 12/06; H01B 12/16; H01R 4/68; H01F 2006/001

(57) ABSTRACT

An electrical cable having two ends and including a plurality of sub-cables extending between the two ends of the cable. The sub-cables are electrically insulated from one another along their lengths and each sub-cable provides a respective alternative electrical current path between the two ends of the cable. Each sub-cable includes: a superconductor portion including a plurality of high temperature superconducting (HTS) tapes including HTS material; and a resistor connected in series with the superconductor portion.

### FIELD OF THE INVENTION

The present invention relates to high temperature superconductor (HTS) cables comprising multiple sub-cables.

### BACKGROUND

Superconducting materials are typically divided into “high temperature superconductors” (HTS) and “low temperature superconductors” (LTS). LTS materials, such as Nb and NbTi, are metals or metal alloys whose superconductivity can be described by BCS theory. All low temperature superconductors have a self-field critical temperature (the temperature above which the material cannot be superconducting, even in zero magnetic field) below about 30 K. By contrast, the behaviour of HTS material is not described by BCS theory, and such materials may have critical temperatures above about 30 K. The most commonly used HTS are “cuprate superconductors”—ceramics based on cuprates (compounds containing a copper oxide group), such as BSCCO (Bismuth strontium calcium copper oxide), or ReBCO (Rare-earth barium copper oxide, where Re is a rare earth element, commonly Y or Gd). Other HTS materials include iron pnictides (e.g. FeAs and FeSe) and magnesium diboride (MgB₂).

ReBCO superconductors are typically manufactured as tapes approximately 100 microns thick and with a width of between 2 mm and 12 mm. The structure of a typical tape is illustrated in FIG. 1 and includes a substrate 101 (typically an electropolished nickel-molybdenum alloy, e.g., Hastelloy™ approximately 50 microns thick), on which is deposited a series of buffer layers known as the buffer stack 102, of approximate thickness 0.2 microns. An epitaxial ReBCO-HTS layer 103 overlays the buffer stack, and is typically 1 micron thick. A 1-2 micron silver layer 104 is deposited on the HTS layer, and a copper stabilizer layer 105 is deposited on and often completely encapsulates the tape. The silver layer 104 and copper stabilizer layer 105 are also deposited on the sides of the tape 100 and the substrate 101 (not illustrated in FIG. 1 for clarity), so that these layers extend continuously around the perimeter of the tape 100, thereby allowing an electrical connection to be made to the ReBCO-HTS layer 103 from either face of the tape 100. These layers 104, 105 may therefore also be referred to as “cladding”. The silver layer 104 makes a low resistivity electrical interface to the ReBCO layer 103, whilst the copper layer 105 enables external connections to be made to the tape (e.g. by soldering) and provides a parallel conductive path for electrical stabilisation.

An HTS cable comprises one or more HTS tapes, which are connected along their length via conductive material (normally copper). The HTS tapes may be stacked (i.e. arranged such that the HTS layers are parallel), or they may have some other arrangement of tapes, which may vary along the length of the cable.

When describing coils in this document, the following terms will be used:
“HTS cable”—a cable comprising one or more HTS tapes. In this definition, a single HTS tape is an HTS cable.
“turn” (or “winding”)—a section of HTS cable within a coil which encloses the inside of the coil (i.e. which can be modelled as a complete loop).
“arc”—a continuous length of the coil which is less than the whole field coil
“critical current”—the current at which the HTS would become normal, for a given temperature and external magnetic field. HTS is considered “become normal” at a characteristic point of the superconducting transition, where the tape generates a critical electric field of E₀ volts per metre. The choice of E₀ is to some extent arbitrary, but is usually taken to be 10 or 100 microvolts per metre.
“critical temperature”—the temperature, Tc, at which the HTS would become normal, at a given magnetic field and current (strictly, the term “critical temperature” is formally defined for zero magnetic field, but the term is used more generally herein for convenience).
“peak critical temperature”—the temperature at which the HTS would become normal given no external magnetic field, and negligible current.
“generation temperature” (or “current-sharing temperature”)—the temperature at which the HTS material generates heat because it is unable to fully carry the current flowing through it. Typical generation temperatures of around 35 K are found for ReBCO material in an HTS field coil in which the current is around 80% of the critical current (lc) and the magnetic field strength is around 20 T.

A superconducting magnet is formed by arranging HTS cables (or individual HTS tapes) into coils, either by winding the HTS cables or by providing sections of the coil made from HTS cables and joining them together. HTS coils come in three broad classes: Insulated, having electrically insulating material between the turns (so that current can flow only in a “spiral path” through the HTS cables, i.e. around the turns).
Non-insulated, where the turns are connected radially, as well as along the cables (e.g. by connecting the copper stabilising layers of the HTS cables).
Partially insulated, where the turns are connected radially with a controlled resistance, either by the use of materials with a high resistance (e.g. compared to copper), or by providing intermittent insulation between the coils.

Non-insulated coils can also be considered as the low-resistance case of partially insulated coils. Partially insulated field coils are described in WO2019150123, for example.

Wound coils, as shown in FIG. 2, are manufactured by wrapping an HTS cable 201 around a former 202 in a continuous spiral. Sectional coils, as shown schematically in FIG. 3, are composed of several sections 301, each of which may contain several cables or preformed busbars 311 and will form an arc of the overall coil. The sections are connected by joints 302 to form the complete coil. While the turns of the coils in FIGS. 2 and 3 are shown spaced apart for clarity, there will generally be material connecting the turns of the coil, e.g. they may be consolidated by potting with a suitable material such as an epoxy.

FIG. 4 shows an HTS tape 400 (in this case a ReBCO tape), illustrating an x, y, z orthogonal coordinate system which will be used in this document. The y axis is along the length of the tape (i.e. in the direction of the current when the tape is in use), the x axis is across the width of the tape, the z axis is through the thickness of the tape (i.e. normal to the plane of the tape).

FIG. 5 shows a cross section of an exemplary HTS tape in the x/z plane. The tape is shown in simplified form with an HTS layer 501, a copper cladding 502, and a substrate 503. The crystal structure of ReBCO has three orthogonal principal axes, referred to in the art as a, b, and c. In FIG. 5 the a/b plane of the ReBCO layer 501 is shown as a single line 510, perpendicular to the c-axis 520.

The critical current of the tape (as well as the generation temperature) depends on the ReBCO crystal thickness and quality, temperature and the magnitude of an external magnetic field, and the orientation of the magnetic field with respect to the c-axis. Typically, when the applied magnetic field vector lies in the a/b plane 510 the critical current is considerably higher than when the applied magnetic field vector is aligned along the c-axis 520, with a smooth variation between these two extremes. In practice, there may be more than one angle at which critical current shows a peak, variation with temperature and magnetic field, and/or variation within the a/b plane but, in a simple analysis, we can consider a tape with a single dominant peak that defines the optimum orientation of the applied magnetic (B) field that gives maximum critical current. ReBCO tapes are normally manufactured so that the c-axis is as close to perpendicular to the plane of the tape as possible (i.e. to be parallel to the z-axis), such that the critical current is maximised when an applied magnetic field is parallel to the plane of the tape.

Direct current (DC) power losses in a superconducting material are generally negligible as the DC resistance of the superconducting state is zero. However, power losses are still possible when a superconducting material experiences time-varying magnetic fields or time-varying electric fields. These losses are sometimes referred to as “AC losses” but, as they can be caused by any dynamic or transient changes in magnetic or electric fields, they are referred to herein as “time-varying field losses”. Such losses are a significant issue for superconducting materials because they generate heat, which may raise the temperature of the superconducting material above its current-sharing temperature. Above the current-sharing temperature, current is forced to flow from superconducting regions of the material into neighbouring normal conductive material. Resistive heating of the normal conductive material may then cause hotspots in a superconducting magnet where the temperature increases dramatically. In such cases, the magnet needs to be rapidly warmed or “quenched” to avoid damage. Even small amounts of power generated by time-varying field losses may therefore be unacceptable for superconductor-based magnets.

A number of mechanisms may contribute to time-varying field losses within a superconducting material. One type of time-varying field loss is termed “hysteresis loss”, which may occur when variations in the transport current flowing through the superconducting material, or changes in an applied magnetic field, induce a voltage which drives current loops (screening currents) in the superconducting material. Another type of time-varying field loss is termed “coupling loss”, which occurs when changing magnetic fields induce a voltage between two superconducting elements that drives current through a resistive interface or join between the two elements.

Hysteretic losses depend on the area of superconducting material that can carry current loops. Since a typical HTS tape has a width of several millimetres, and a consequentially large area, hysteretic losses are a significant factor in HTS tapes experiencing a rapidly changing electric or magnetic field, such as when ramping up an HTS field coil. Using narrower pieces of HTS tape trivially reduces the cross-sectional area but reduces the tape's current carrying capacity. A coil wound from narrower tape cannot generate as strong a magnetic field. Forming an equivalent strength magnet typically requires joining multiple coils via resistive interfaces, which increases coupling losses. A piece of HTS tape can be striated along its length to create multiple filaments connected in parallel with one another, but striated tapes typically have high coupling losses between filaments. Cables can also be twisted or created by winding HTS tapes helically around a core, which reduces the effective area over which currents can be induced by a changing magnetic field. One type of twisted cable is “Conductor on Round Core” (CORC®) cable. Twisting a cable again limits the current carrying capacity of the cable because unfavourable orientations between the c-axis of the superconducting material and applied magnetic fields are generated.

What is needed is a superconducting cable or other current-carrying assembly, particularly a cable made from HTS tapes, that reduces both hysteretic losses and coupling losses (i.e., time-varying field losses) without sacrificing current-carrying capacity.

### SUMMARY

According to a first aspect of the present invention there is provided an electrical cable having two ends and comprising a plurality of sub-cables extending between the two ends of the cable. The sub-cables are electrically insulated from one another along their lengths and each sub-cable provides a respective alternative electrical current path between the two ends of the cable. Each sub-cable comprises: a superconductor portion comprising a plurality of high temperature superconductor (HTS) tapes comprising HTS material (e.g. ReBCO); and a resistor (e.g. at least one resistor, two or more resistors etc.) connected in series with the superconductor portion.

Including the resistors in the sub-cables can allow induced electrical currents that flow between pairs of the sub-cables when the cable is used in an electrical circuit to be suppressed. In particular, the electrical cable can be configured such that a current induced to flow through the cable between any two of the sub-cables (i.e. from one sub-cable to another sub-cable within the cable) is required to flow through the resistors of the two sub-cables, i.e. there is no conductive loop or closed path in the cable that comprises the two sub-cables and that does not pass through two or more of the resistors. Thus, coupling currents between the sub-cables can be suppressed, leading to less heating of the sub-cables and more stable operation of the superconductor portions. For example, screening currents may generally be isolated to each sub-cable individually. Compared to a cable of an equivalent width having a single sub-cable, the total amount of time-varying field losses (i.e. coupling and hysteretic losses) in the electrical cable of the present disclosure may be reduced by a factor that is equal to, or proportional to, the number of sub-cables in the cable, e.g. for a certain amount of heating, P (in Watts), the total amount of heating in a cable having n sub-cables may be reduced to around P/n.

In general, each sub-cable provides a conductive pathway that allows electric current to pass from one end of the cable to the other end of the cable. A single power supply may be used to supply electric current to all the sub-cables simultaneously. In some cases, each of the sub-cables may be substantially equivalent, such that the electric current divides substantially equally between them.

Each sub-cable may comprise two resistors connected in series with the superconductor portion on opposite ends of superconductor portion of the cable (i.e. the resistor and another resistor, which may be the same as or different from the resistor). This arrangement can allow heat to be dissipated from both ends of the cable, thereby reducing (e.g. halving) the cooling power that needs to be supplied to any one end of the cable.

Each resistor may be connected to the superconductor portion of the corresponding sub-cable by a respective current lead. This arrangement reduces the thermal load on the superconductor portions and facilitates cooling of the resistors separately from the superconductor portions. To increase the proportion of power dissipated in the resistor(s), each resistor may have or may be configurable to have a resistance that is significantly greater than a resistance of the current lead. In some implementations, the resistor may have a resistance of from 0.1 to 100 milliohms, or from 1 to 10 milliohms. The current leads may have a cross sectional area that is greater than a cross sectional area of the superconductor element e.g. the current leads may have a diameter that is greater than a diameter of the superconductor element.

The electrical cable may further comprise a cooling mechanism, such as a cryostat, for cooling the superconductor portion of each sub-cable below a superconductor transition temperature of the HTS material of the HTS tapes while the resistor remains at a temperature above the superconductor transition temperature of the HTS material. This arrangement has the advantage that at least some coupling currents can be dissipated in the resistors at a higher temperature (using another cooling mechanism, e.g. a liquid nitrogen or water cooling mechanism), rather than at or below the superconductor transition temperature, thereby reducing the heat load on the cooling mechanism used to keep the HTS material in a superconducting state. For example, the HTS material may be maintained at a temperature of around 20 K (or below), whilst the resistors are maintained at a temperature of around 77 K (which is attainable with liquid nitrogen cooling), or room temperature, e.g. 300 K (or more).

The superconductor portions of the sub-cables may be elongate, with a largest dimension (length) that extends (generally) along the cable. Each superconductor portion may be untwisted, such that it does not follow a spiral or helical path within the cable (although the cable itself may bend or it may be wound around an axis, e.g. to form a coil). For example, the orientation of the HTS tapes in the superconductor portion may remain substantially constant with respect to other parts of the sub-cable, e.g. when cross sections through the sub-cable are taken at any two points along its length, a vector normal to the HTS tapes in a first of the cross sections may be substantially parallel to a vector normal to the HTS tapes in a second of the cross sections.

Having the superconductor portions of the sub-cables untwisted means that the HTS tapes may have a constant (or nearly constant) orientation with respect to a magnetic field. In particular, in use, each superconductor portion may be arranged such that one or more principal crystal axes of the HTS material can have orientations with respect to a magnetic field that remain at least approximately constant (i.e. differ by less than a predetermined absolute or relative amount) along the length of the superconductor portion. For example, the superconductor portions of the sub-cables may be wound into a coil (e.g. a solenoid or pancake coil) such that a principal crystal axis of the HTS material is oriented perpendicular to the windings, e.g. where the windings are about an axis of the coil, the principal crystal axis may be oriented radially with respect to the coil axis. In the case of the HTS material being ReBCO, such orientations may allow the field vector of the magnetic field generated by the coil to lie (at least predominantly) in the a/b plane of the superconductor material to obtain an optimal (or near optimal) maximum critical current. By contrast, for cables in which the sub-cables are twisted (about one another and/or individually twisted), the orientation of the HTS material varies along the length of the sub-cable, which may reduce the critical current of the HTS material as a result of the material's anisotropic critical current dependence on the angle between the principal crystal axis and the magnetic field. Thus, the HTS material in the present electrical cable may be operated at higher currents compared to HTS material in cables that are twisted.

Accordingly, in some implementations, the HTS tapes of each sub-cable can be arranged in a stack and can be (substantially) untwisted.

Alternatively, in some implementations, the superconductor portions of the sub-cables may be twisted about one another, or individually twisted about themselves, to further reduce losses. The superconductor portions may have any twist pitch length appropriate for the materials used, e.g. the twist pitch length may be from 2 to 10 times a width of the HTS tapes in a direction transverse to their length. The twist pitch length refers to a length measured along the cable (i.e. longitudinally with respect to the cable) over which the HTS tapes make a complete revolution about each another, i.e. the distance over which the relative orientations of the HTS tapes repeat. For some applications, it may be preferable to have relatively long twist pitch lengths to avoid issues with tightly twisting the HTS tapes, e.g. a twist pitch length greater than 5 times, or greater than 10 times, or greater than 100 times, a width of the HTS tapes in a direction transverse to their length. In some examples, the twist pitch length may be in a range from 10 to 1000, from 50 to 100, or from 500 or 1000 times the widths of the HTS tapes. Such cables may be easier to manufacture and/or have less strain compared to more tightly twisted cables. In addition, the superconductor portions may be twisted about one another for only a fraction (e.g. less than 10%, less than 20% or less than 50%) of the twist pitch length, such that the HTS tapes may have a constant orientation with respect to an applied magnetic field for the remainder of the twist pitch length, i.e. the superconductor portions may be untwisted about one another for more than 90%, more than 80% or more than 50% of their length.

The sub-cables may be electrically insulated from one another along their lengths by electrical insulator material (such as a polyimide film, epoxy resin or a suitable potting or encapsulation compound) provided between the sub-cables.

One or more (e.g. each) of the sub-cables may comprise a diode configured to allow current to flow preferentially through the sub-cable in one direction only. Each diode limits a “backflow” of current through the sub-cable, further reducing the magnitude of coupling currents flowing between the sub-cables and reducing total power losses due to such currents in the cable. For implementations in which two or more of the sub-cables comprise diodes, the direction in which current flows preferentially through the diodes is preferably the same for each of the sub-cables.

In some implementations, each superconductor portion is arranged to form turns of a superconductor magnet coil. For example, the coil may be formed by winding the superconductor portions about an axis. As noted above, the superconductor portions are preferably untwisted about one another, which may allow, for example, the HTS material to be aligned with respect to a magnetic field generated by the coil (e.g. a solenoidal magnetic field) to optimise the critical current of the HTS material and/or limit the amount of hysteresis loss (which may be produced by magnetic field components perpendicular to the ab-plane in ReBCO, for example).

In some implementations, the electrical cable is configured such that: an induced electrical current that flows between sub-cables when the sub-cables experience a time-varying electromagnetic field in use flows through at least one resistor of a sub-cable; and/or induced electrical currents that flow between pairs of the sub-cables when the cable is used in an electrical circuit are suppressed.

In implementations, the electrical cable can be configured so that any closed loop in the electrical cable that comprises two sub-cables of the plurality of sub-cables includes the respective resistances of the two sub-cables.

In some implementations, the superconductor portion of each sub-cable can be wound into a respective magnetic field coil, the magnetic field coils being arranged adjacent to one another and electrically insulated from one another.

In some implementations, the superconductor portions of each sub-cable are arranged such that planes of each HTS tape of each sub-cable are substantially parallel with each other at each point along a length of the current-carrying arrangement.

In some implementations, each superconductor portion is wound into a magnetic field coil and the plane of the or each HTS tape of each sub-cable is substantially aligned with a magnetic field generated in use of the field coil.

One or more (e.g. each) of the resistors may be a variable resistor. The variable resistor(s) may be used to adjust the resistance of the sub-cable(s) to control the magnitude of coupling currents that can flow between them. For example, the resistance of each of the sub-cable may be increased to decrease the magnitude of coupling currents as the current through the cable is increased. The resistance of each of the sub-cables may be subsequently decreased once steady-state current flow through the cable has been attained. Alternatively or additionally, the variable resistor(s) may be used to direct electric current preferentially to sub-cables that are at substantially the same voltage as one another, such that the magnitude of any coupling currents flowing between these sub-cables is small. The variable resistor(s) may also be used to reduce the total current flowing through a sub-cable that is damaged and/or under-performing (e.g. has a lower critical current) and thereby divert current through sub-cables that are undamaged and/or performing satisfactorily. In some implementations, the resistance of the variable resistor(s) may be adjusted according to a measured parameter of one or more of the sub-cables, e.g. a critical current or temperature.

According to a second aspect of the present invention, there is provided a superconductor magnet comprising an electrical cable according to the first aspect of the present invention. The superconductor portions of the sub-cables are wound into at least one coil, e.g. the magnet may comprise a plurality of turns or windings of each superconductor portion about an axis. The coil may, for example, be a solenoid or a pancake coil (in which windings or turns of the coil are nested radially).

According to a third aspect of the present invention, there is provided a system comprising an electrical cable according to the first aspect or a superconductor magnet according to the second aspect in which one or more of the resistors is a variable resistor. The system further comprises a controller for adjusting the resistance of each of the variable resistors. The controller may be configured to measure respective voltages of and/or currents flowing through the sub-cables and to adjust the resistance of one or more of the variable resistors in response to a voltage and/or current difference measured between two of more of the sub-cables. The cable may be wound in a coil, for example.

The system may comprise an adjustable power supply connected across the electrical cable, the controller being configured to adjust a voltage applied by the power supply across the electrical cable, and/or a current supplied by the power supply to the electrical cable, in response to the resistances of the variable resistors being adjusted. For example, the voltage may be increased according to the total resistance of the cable in order to maintain a constant total current flowing through the cable.

According to a fourth aspect of the present invention, there is provided a method of operating an electrical cable according to the first aspect above. The method comprises applying a voltage difference across the electrical cable to drive electrical current therethrough, i.e. from one end of the cable to the other end. The method further comprises adjusting the resistance of one or more of the variable resistors as a function of at least one or more of: time after applying the voltage difference across the electrical cable, the electrical current flowing through the electrical cable or the electrical current flowing through one or more of the sub-cables, a magnetic field generated by the electrical cable, and/or a voltage difference across the superconductor cable or across pairs of sub-cables.

Adjusting the resistance of one or more of the variable resistors may comprise decreasing the resistance of the one or more variable resistors after the electrical current flowing through the electrical cable and/or the magnetic field generated by the electrical cable has reached a steady state (e.g. has reached a value that is within a predetermined range of a target value or has reached a state where variations in the value are less than a predetermined fraction of the value).

Adjusting the resistance of one or more of the variable resistors may comprise adjusting the resistance of the one or more variable resistors to divert current preferentially through one or more of the sub-cables. For example, current may be diverted away from sub-cables for which coupling losses are significant (e.g. as determined by the voltages of the sub-cables) and through sub-cables for which coupling losses are smaller.

According to a further aspect of the present invention there is provided a superconductor cable (or current-carrying arrangement) comprising a plurality of sub-cables extending between opposite ends of the cable and electrically insulated from one another along their lengths. The sub-cables are arranged in parallel with one another to provide respective alternative paths for electric current to flow between the ends of the cable. Each sub-cable includes a superconductor element comprising superconductor material arranged to conduct electrical current along the cable and at least one resistor connected in series with the superconductor element. Induced electrical currents that flow between pairs of the sub-cables when the cable is used in an electrical circuit are thereby suppressed.

In another aspect, the present invention provides a current-carrying assembly comprising a plurality of sub-cables, the sub-cables being electrically connected or connectable in parallel with one another via shared connections at opposite ends of the current-carrying assembly and otherwise being electrically insulated from one another, each sub-cable comprising: a superconductor portion comprising superconductor material; and a resistance in series with the superconductor portion; whereby an induced electrical current that flows, or would flow, between sub-cables via the connections when the sub-cables experience a time-varying electromagnetic field in use flows through at least one resistance of a sub-cable. Optionally, the superconductor portion comprises at least one tape or flat wire, and the respective superconductor portions of the sub-cables are arranged adjacent each other such that respective planes of the or each tape of each sub-cable are substantially parallel or aligned with each other at each point along a length of the current-carrying assembly. In other words, the tapes are parallel when viewed in cross-section through any given plane perpendicular to a tangent of the current-carrying arrangement at that point.

### BRIEF DESCRIPTION OF THE DRAWINGS

FIG. 1 is a schematic representation of an HTS tape;

FIG. 2 is a schematic representation of a wound HTS coil;

FIG. 3 is a schematic representation of a sectional HTS coil;

FIG. 4 is a diagram showing a coordinate system for describing ReBCO tape;

FIG. 5 is a transverse cross section of a ReBCO tape, showing the principal axes of the ReBCO crystal;

FIG. 6 is a schematic circuit diagram showing an embodiment of the present invention; FIG. 7 is a schematic circuit diagram showing another embodiment of the present invention; and FIG. 8 is a schematic cross section view of a plurality of sub-cable superconductor portions arranged in a cable.

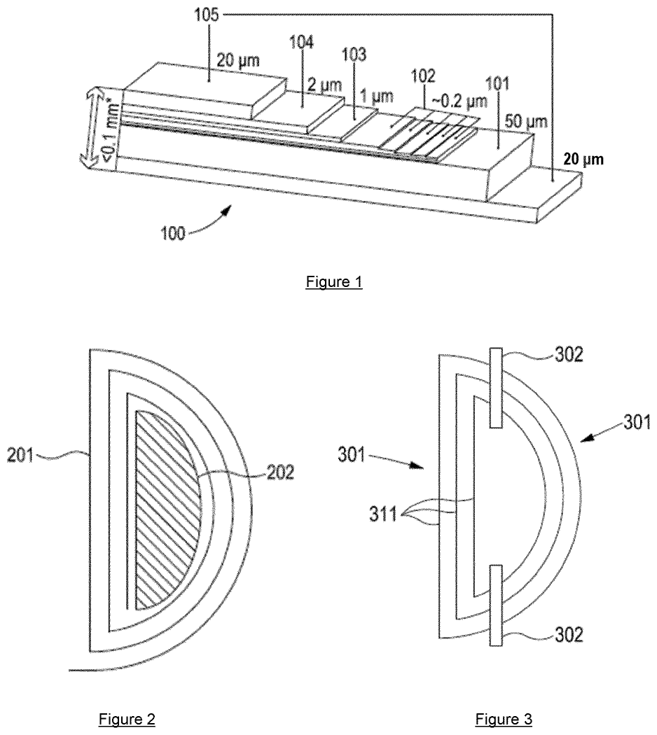

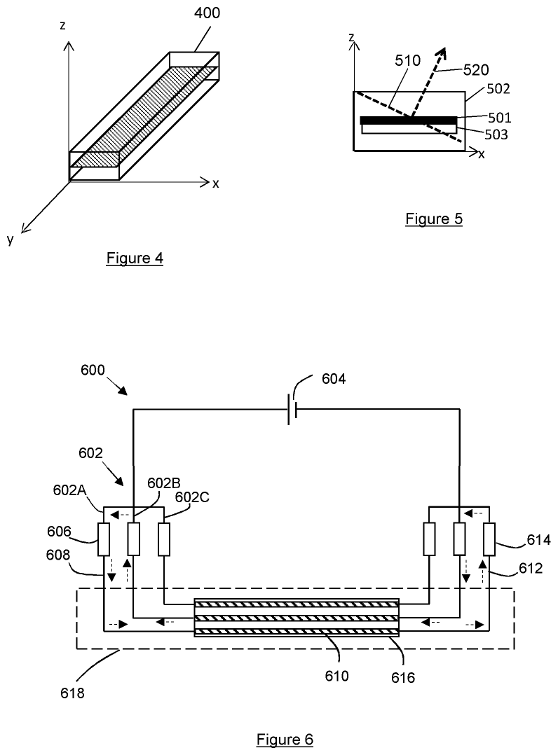

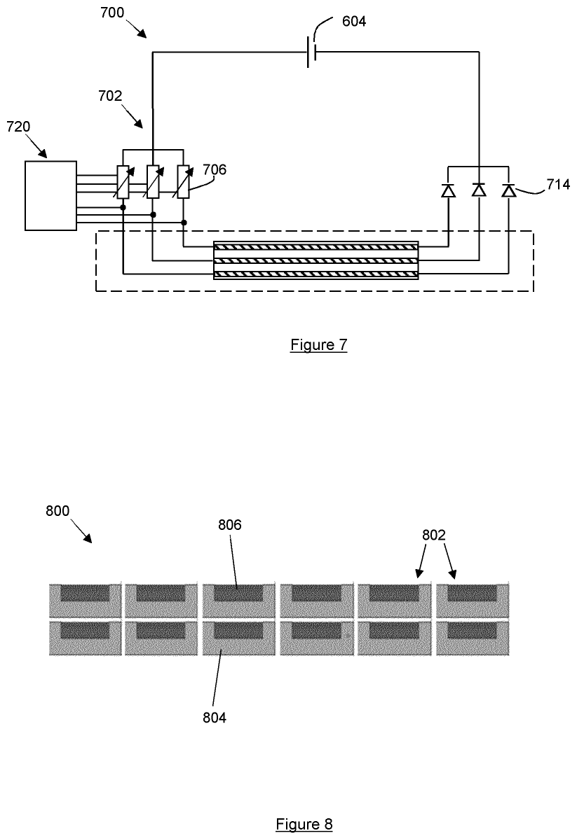

### DESCRIPTION OF EMBODIMENTS

Embodiments of the present invention reduce hysteretic losses in an HTS superconductor cable by arranging HTS material as a plurality of sub-cables. This arrangement reduces the available area of the HTS material within which screening currents can form compared to a full width cable. Coupling currents between the sub-cables are suppressed by electrically insulating the sub-cables from one another along their length. The sub-cables are electrically connected in parallel with one another and loop currents (with associated losses) may still occur between pairs of sub-cables via their shared connections. These loop currents are suppressed by introducing a resistor (at least one resistor) into each sub-cables, such that any losses occur substantially only in the resistor.

Overall, embodiments of the present invention significantly reduce coupling between sub-cables and isolate screening currents to occur within (narrow) sub-cables rather than across a full width cable. Reducing time-varying field losses in this way may allow other (potentially disadvantageous) ways of reducing this type of loss, such as twisting of the sub-cables, to be avoided. Embodiments of the present invention therefore reduce or avoid the trade-off between hysteretic losses and coupling currents in existing superconductor cables. The present approach is particularly suitable for HTS superconductor materials in the form of tapes (or flat wires) since the tapes can be aligned with a magnetic field direction generated by a field coil wound from the cable to minimise reductions in critical current caused by unfavourable orientations.

FIG. 6 shows a circuit comprising a superconductor cable 602 having a plurality of sub-cables 602A-C electrically connected in parallel between the two ends of the cable 602. A power supply is connected across the two ends of the cable 602 to drive electric current through each of the sub-cables 602A-C. Each sub-cable 602A-C is electrically insulated from the other sub-cables along its length, such that any electric current flow between sub-cables, caused by a potential difference between them, necessarily flows through the ends of the of the cable 602, where the sub-cables are connected, rather than through any intermediate part of the cable 602 located between the ends of the cable 602. Each sub-cable 602A-C may be considered as (or comprising) a sub-cable, and the plurality of sub-cables together form the cable or, generally, a current-carrying assembly. The cable 602 illustrated in FIG. 6 has three sub-cables 602A-C, but in general the cable 602 may have any integer number of sub-cables greater than or equal to two, e.g. 2, 5, 10, 12 or 20 sub-cables. In some cases, each of the sub-cables may experience essentially the same rate of change of magnetic field (dB/dt), such that the voltage differences across the cables are expected to be small. In the absence of the resistors, even such small voltage differences may induce large currents to flow between the sub-cables. However, in the circuit of FIG. 6, these currents are limited by the resistors in the sub-cables, thereby reducing resulting power losses.

Each sub-cable comprises a respective plurality of components connected in series, the components comprising (in order, from left to right in the figure) a first resistor 606, a first current lead 608, a superconductor portion 610, a second current lead 612 and a second resistor 614. The first and second current leads 608, 612 may comprise normal conductor material, e.g. copper wire, or superconducting material however, in general, any form of electrical conductor may be used, e.g. superconductor wires.

The superconductor portions 610 each comprise HTS material (such as ReBCO), in the form an elongate body, such as a wire or tape. In the superconductor cable 602 of FIG. 6, the superconductor portions 610 each comprise a single HTS tape, although each superconductor portion 610 may alternatively comprise a plurality of HTS tapes connected in parallel or in series with one another (or in some combination of series and parallel arrangements). Each superconductor portion 610 may be arranged as a stack of HTS tapes, for example.

The resistors are configured to reduce the magnitude of coupling currents that flow between pairs of the sub-cables 602A-C as a result of a voltage difference between the sub-cables 602A-C. An example of such a coupling current is illustrated in FIG. 6 by the dashed arrows provided adjacent to two of the sub-cables 602A-B. The coupling current flows in a closed loop spanning the lengths of the sub-cables 602A-B and passing through each of the resistors 606, 614 at either end of each of the sub-cables 602A-B. The inclusion of the resistors 606, 614 in the superconductor cable 602 limits the magnitude of the coupling currents that can flow for a given voltage difference between the sub-cables 602A-B. The resistance of each resistor 606, 614 is preferably greater than the resistance of each of the current leads 608, 612, such that heating resulting from the coupling current occurs predominantly in the resistors 606, 614, rather than the current leads 608, 612. The resistance of each resistor 606, 614 is also preferably chosen or adjusted so that a supplied current splits substantially equally between the sub-cables 602A-C. Conveniently, for example, each resistance is substantially equal, all other elements of each sub-cable 602A-C being substantially identical. More generally, the total resistance of each sub-cable 602A-C is substantially the same to achieve an even current split between sub-cables (although this is not essential). The values of the resistances are chosen at least in part according to a desired power dissipation in use, and may typically be in the range from 0.1 to 100 milliohms, for example.

The superconductor portions 610 of the sub-cables are placed in a desired arrangement to collectively form a superconducting section 616 of the cable 602. The superconducting section 616 may be arranged as a magnetic field coil wound from adjacent sub-cables 602A-C, for example. The field coil may be wound in the form of a pancake coil, a solenoid, or any other suitable arrangement Alternatively, each sub-cable 602A-C may be wound into a separate field coil (e.g., a pancake coil) and the field coils arranged adjacent each other to form a composite magnet.

Where the superconductor portions 610 each comprise one or more substantially flat tapes, they may be arranged adjacent each other such that the tapes are all substantially aligned, lying in substantially the same plane, at each point along the length of the superconducting section 616. The individual tapes, and/or the a/b planes of each tape, can all therefore be substantially aligned with a magnetic field generated by a field coil wound from the cable. For example, in a pancake coil the vectors normal to the tapes can all lie in the plane of the coil or, in a straight solenoid, the vectors normal to the tapes can all be perpendicular to the solenoid's axis.

Additionally, the superconducting section 616 can have a desired width formed by a plurality of sub-cables 602A-C placed side-by-side. The resulting arrangement will have a current density similar to an equivalent full-width cable but with hysteretic losses reduced by a factor approximately equal to the number of sub-cables.

Embodiments of the present invention therefore provide a cable in which sub-cables can be substantially untwisted along their length relative to a magnetic field direction This enables the superconductor material in each sub-cable to have a greater critical current and hence to be operated at higher transport currents than in twisted tape cables, enabling the generation of stronger magnetic fields. Simultaneously, time-varying field losses are reduced compared to a cable without sub-cables and having the same or an equivalent width such that a cable embodying the present invention can be used in a magnet that is intended to be ramped up or down rapidly, or will otherwise be subjected to changing electromagnetic fields.

In use, the superconductor portions 610 are located within a cryogenically cooled region 618 such as within a cryostat (although other types of cooling system can be used) that maintains the superconductor material at a temperature below a superconductor transition temperature of the superconductor material (e.g. around 20 K for some HTS materials). The resistors 606, 614 may be located outside of the cryostat or within a higher temperature region of the cryostat to reduce the heat load on the cryostat resulting from the power dissipated within the resistors 606, 614. For example, the resistors 606, 614 may be located in a substantially room temperature region (or at least above 273 K) and cooled with water.

In some implementations, some or all of the sub-cables 602A-C may comprise only a single resistor 606, 614. Alternatively, some or all of the sub-cables may comprise two or more resistors 606, 614, which advantageously causes heat to be more evenly between the resistors, reducing the cooling power required for each resistor.

FIG. 7 shows a circuit 700 that is largely the same as the circuit 600 of FIG. 6, except that each sub-cable of the superconductor cable 702 comprises a variable resistor 706 and a diode 714 (as opposed to the constant resistance resistors 606, 614). The circuit 700 also comprises a controller 720 that is configured to adjust the resistance of the variable resistors 706 in response to measured currents flowing through each of the sub-cables and/or measured voltages between or along the sub-cables. The controller may, for example, be a feedback controller (e.g. a proportional integral derivative, PID, controller). The controller 720 may, in some implementations, adjust the resistance of some or all of the variable resistors 706 to ensure that any voltage differences between or along the sub-cables remain at values below a predetermined maximum voltage difference. Additionally, the resistances of the variable resistors 706 may be reduced to (or near to) zero when the superconductor cable 702 is not subject to a time-varying magnetic field, e.g. when a field coil is being maintained in a steady state rather than being ramped up or down.

The diodes 714 included in the sub-cables may further reduce coupling currents flowing between the sub-cables, although including diodes may require higher voltages to be generated by the power supply 604 to drive current through the cable 702. In some cases, diodes may be included in place of one or more of the resistors (e.g. in some cases each of the resistors may be replaced by one or more diodes).

The voltage of the power supply 604 may be varied to allow the current flowing through the superconductor cable 602, 702 to be adjusted. For example, the voltage of the power supply 604 may be increased in response to the resistances of the variable resistors 714 being increased. In some cases, the controller 720 may be used to adjust the voltage of the power supply 604 to ensure that the total current flowing through the cable 702 remains constant (i.e. remains within a predefined target range).

FIG. 8 shows a cross section through a superconductor section 800 of a superconductor cable 602, 702 comprising sub-cables providing a plurality of superconductor portions 802. Each superconductor portion 802 comprises a supporting structure comprising a channel 804, that may be generally U-shaped, that houses a stack 806 of HTS tapes. The channel 804 may comprise copper and/or aluminium, for example, or another metal or be formed from a suitable material. The HTS tape may be ReBCO tape, for example. In some implementations, the channel 804 may comprise an insulating layer to electrically insulate the stack 806 of HTS tapes from the channel 804 and/or adjacent channels from each other. The depth of the channel 804 and the thickness of the stack 806 may be adjusted depending on the operating current and inductance required. In some examples, the channel 804 may provide a normal conductive path for electrical current in the event of the superconductor material becoming non-superconducting, e.g. in the event of a quench.

The superconductor portions 802, with or without a channel 804 or other supporting structure, may be arranged in an array, e.g. a 2 by 6 array of superconductor portions 802 as illustrated in FIG. 8, or any other suitable arrangement. The superconductor portions 802 may be spaced apart from one another, with the spaces between the portions filled with an insulator material such as an epoxy resin. The insulator material may additionally provide structural support for the superconductor portions 802.

The superconductor cables described above may be wound into a coil to manufacture a superconductor electromagnet. Such electromagnets may be used in many different applications, including superconductor magnetic energy storage (SMES, e.g. for electrical power grid stabilisation), plasma confinement and control such as in a tokamak or stellarator, magnetic resonance imaging (MRI) and/or NMR spectroscopy, hadron therapy, aerospace applications, included in aircraft, unmanned aerial vehicles, satellites, spacecraft, rocket-propelled vehicles and autonomous exploration vehicles.

1. An electrical cable having two ends and comprising a plurality of sub-cables extending between the two ends of the cable, the sub-cables being electrically insulated from one another along their lengths and each sub-cable providing a respective alternative electrical current path between the two ends of the cable, each sub-cable comprising:
a superconductor portion comprising a plurality of high temperature superconductor (HTS), tapes comprising HTS material; and
a resistor connected in series with the superconductor portion.

2. An electrical cable according to claim 1, wherein each sub-cable comprises two resistors connected in series with the superconductor portion on opposite ends of the superconductor portion of the sub-cable.

3. An electrical cable according to claim wherein each resistor is connected to the superconductor portion of the corresponding sub-cable by a respective current lead, each resistor having or being configurable to have a resistance that is greater than a resistance of the corresponding current lead.

4. (canceled)

5. An electrical cable according to claim 1, further comprising a cooling mechanism for cooling the superconductor portion of each sub-cable below a superconductor transition temperature of the HTS material of the HTS tapes while each resistor remains at a temperature above the superconductor transition temperature of the HTS material.

6. An electrical cable according to claim 1, wherein the superconductor portions of each sub-cable are arranged in parallel with one another and are substantially untwisted around one another.

7. An electrical cable according to claim 1, wherein the HTS tapes of each sub-cable are arranged in a stack and are substantially untwisted along the length of the sub-cable.

8. An electrical cable according to claim 1 wherein one or more of the sub-cables comprises a diode.

9. An electrical cable according to claim 1, wherein each superconductor portion is arranged to form turns of a superconductor magnet coil.

10-11. (canceled)

12. An electrical cable according to claim 1, wherein the superconductor portion of each sub-cable is wound into a respective superconductor magnet coil, the superconductor magnet coils being arranged adjacent to one another and electrically insulated from one another.

13. An electrical cable according to claim 1, wherein the superconductor portions of each sub-cable are arranged such that planes of each HTS tape of each sub-cable are substantially parallel with each other at each point along a length of a current-carrying arrangement.

14. (canceled)

15. An electrical cable according to claim 1, wherein the resistor of at least one of the sub-cables is a variable resistor.

16. (canceled)

17. A system comprising an electrical cable according to claim 15, and a controller for adjusting the resistance of the or each variable resistor, wherein the controller is configured to measure respective voltages of and/or currents flowing through the sub-cables and to adjust the resistance of the variable resistor in response to a voltage and/or current difference measured between two of more of the sub-cables.

18-19. (canceled)

20. A method of operating an electrical cable according to claim 15, the method comprising:
applying a voltage difference across the electrical cable to drive electrical current therethrough; and
adjusting the resistance of the or each variable resistor in response to a voltage and/or current difference measured between two or more of the sub-cables.

21-22. (canceled)

23. An electrical cable according to claim 12 wherein the HTS tapes in each sub-cable are substantially aligned with a magnetic field generated in use of the respective superconductor magnet coil.

24. A superconductor magnet formed from an electrical cable according to claim 1.

25. A superconductor magnet according to claim 24 wherein the HTS tapes in each sub-cable are substantially untwisted along the length of the of the sub-cable and are substantially aligned with a magnetic field generated in use of the superconductor magnet.
